(19) United States
(12) Patent Application Publication
(10) Pub. No.: US 2010/0003033 A1
(43) Pub. Date: Jan. 7, 2010

(54) Transmission of Audio Signals Via Fibre Optic

(76) Inventor: David Holmes, Romford (GB)

Correspondence Address: HARRINGTON & SMITH, PC, 4 RESEARCH DRIVE, Suite 202, SHELTON, CT, 06484-6212, US

(21) Appl. No.: 11/992,004

(22) PCT Filed: Sep. 12, 2006
(86) PCT No.: PCT/GB2006/050285

§ 371 Date: Aug. 24, 2009

(30) Foreign Application Priority Data
Sep. 13, 2005 (GB) 0518657.2
Feb. 1, 2006 (GB) 0602041.6

(51) Int. Cl. H04B 10/12; H04B 3/00

(52) U.S. Cl. 398/141; 381/77

(57) ABSTRACT

A system received an analogue electrical signal having content between 20 Hz and 20 kHz representing an analogue audio signal; amplitude modulates the analogue electrical signal onto an optical signal; transmits the modulated optical signal over an optical waveguide; receives. The modulated optical signal; and demodulates the modulated optical signal to reproduce the analogue electrical signal. The system may be incorporated within a cable arrangement.

### CROSS REFERENCE TO PRIORITY APPLICATIONS

This application is a US national stage entry from PCT/GB2006/050285 filed on Sep. 12, 2006, and through that PCT application claims priority to GB 0518657.2 (filed Sep. 13, 2005) and GB 0602041.6 (filed Feb. 1, 2006).

### FIELD OF THE INVENTION

This invention relates to handling audio signals.

### BACKGROUND

In a concert environment, it is usual to connect sound sources, including guitars and microphones, to amplification equipment with shielded electrical cables. Such cables have a copper core and a metallic shield separated by an insulating material. At each end, a jack or plug, typically ¼ inch (0.635 cm) diameter, allows both the copper core and the shielding of the cable to be electrically connected to electronic circuitry in the relevant electrical equipment. Signals are carried from the sound source in the same form in which they are generated, i.e. as analogue signals in the audible frequency range 20 Hz to 20 kHz. In a studio environment, the same type of cable connects sound sources to mixing desk equipment. Cables used in concert environments can be over 10 m long, although shorter cables tend to be used in studio environments.

Such cables can become internally damaged during use, especially when being used in an on-stage environment, although they may appear externally to be undamaged. Damaged cables cause a reduction in the quality of signals being carried, often resulting in unwanted distortion or other degradation of the audio signals. If the core of the cable becomes fractured, the cable can stop functioning altogether, although signal deterioration is more common. The inventor considers that signal degradation might result from fractures in the core and/or shielding and/or from damage to the insulating material separating the core from the shielding resulting in unwanted inductances and/or capacitances, which can cause unwanted resonance and/or filtering when supplied with energy in the form of the audio signals being carried.

The effects of cable damage can be avoided through the use of radio links between the sound source and the mixing desk or amplification equipment. Radio microphones are well known. However, the possibility of radio interference means that digital communication links are more reliable. However, musicians and sound producers prefer audio signals not to be digitised at any point in their transmission since this necessarily results in a reduction in quality, as well as a less pure sound.

### SUMMARY

It is an aim of the present invention to mitigate the above-mentioned disadvantages.

According to a first aspect of the present invention there is provided an audio signal communication system comprising:
means for receiving an analogue electrical signal having content between 20 Hz and 20 kHz representing an analogue audio signal;
means for amplitude modulating the analogue electrical signal onto an optical signal;
means for transmitting the modulated optical signal over an optical waveguide;
means for receiving the modulated optical signal; and
means for demodulating the modulated optical signal to produce an analogue electrical signal having audio signal content between 20 Hz and 20 kHz.

By amplitude modulating the audio signals onto an optical signal for transmission, the invention avoids the need to digitise the signals, thereby retaining signal quality and purity, whilst eliminating the possibility of the audio signals being subjected to unwanted capacitances and inductances during communication.

The modulated optical signal preferably comprises an optical carrier with amplitude modulations at between 20 Hz and 20 kHz, the amplitude modulations having direct correspondence with the audio signals. This allows a simple arrangement to be used with minimum possibility for the introduction of signal distortion.

The means for amplitude modulating may comprise a semiconductor circuit arranged to apply a modulating signal to a light source, such as a light emitting diode. The semiconductor circuit could be a transistor based amplifier, such as an operational amplifier.

The means for receiving the analogue electrical signal and the means for amplitude modulating may be integrated into a device having an electrical connector for mating with a sound source. This allows the invention to be used without requiring modified sound source equipment. Alternatively, the means for receiving the analogue electrical signal and the means for amplitude modulating may be integrated into a device comprising a sound source.

The means for receiving the modulated optical signal and the means for demodulating may be integrated into a device having an electrical connector for mating with an audio signal receiving device. This allows the invention to be used without requiring modified sound processing/recording equipment. Alternatively, the means for receiving the modulated optical signal and the means for demodulating may be integrated into an audio signal receiving device. This avoids the need for a separate power supply.

The invention also provides a cable arrangement comprising first and second devices connected by an optical waveguide,
the first device comprising:
   means for receiving an analogue electrical signal having content between 20 Hz and 20 kHz representing an analogue audio signal;
   means for amplitude modulating the analogue electrical signal onto an optical signal; and
   an electrical connector for mating with a sound source;
the optical waveguide being arranged to carry the modulated optical signal to the second device; and
the second device comprising:
   means for receiving the modulated optical signal;
   means for demodulating the modulated optical signal to produce an analogue electrical signal having audio signal content between 20 Hz and 20 kHz; and
   an electrical connector for mating with an audio signal receiving device.

The invention also provides apparatus for communicating an audio signal, the apparatus comprising:
means for receiving an analogue electrical signal having content between 20 Hz and 20 kHz representing an analogue audio signal; and
means for amplitude modulating the analogue electrical signal onto an optical carrier and for transmitting the modulated optical signal.

The invention further provides apparatus for providing an audio signal, the apparatus comprising:
means for receiving an amplitude modulated optical signal; and
means for demodulating the modulated optical signal to produce an analogue electrical signal having audio signal content between 20 Hz and 20 kHz.

A method of communicating audio signals according to the invention comprises:
receiving an analogue electrical signal having content between 20 Hz and 20 kHz representing an analogue audio signal;
amplitude modulating the analogue electrical signal onto an optical signal;
transmitting the modulated optical signal over an optical waveguide;
receiving the transmitted modulated optical signal; and
demodulating the received modulated optical signal to produce an analogue electrical signal having content between 20 Hz and 20 kHz.

Another method of communicating audio signals according to the invention comprises:
receiving an analogue electrical signal having content between 20 Hz and 20 kHz representing an analogue audio signal; and
amplitude modulating the analogue electrical signal onto an optical signal for transmission.

A method of providing an audio signal according to the invention comprises:
receiving an amplitude modulated optical signal; and
demodulating the received modulated optical signal to produce an analogue electrical signal having content between 20 Hz and 20 kHz.

### BRIEF DESCRIPTION OF THE DRAWINGS

Embodiments of the invention will now be described by way of example only with reference to the accompanying drawings, in which:

FIG. 1A is a schematic drawing of circuitry used to provide an amplitude modulated optical signal from an electrical audio signal, according to certain aspects of the invention;

FIG. 1B is a schematic drawing of alternative circuitry used to provide an amplitude modulated optical signal from an electrical audio signal, according to certain aspects of the invention;

FIG. 2 is a schematic drawing of circuitry used to provide an electrical audio signal from an amplitude modulated optical signal, according to certain aspects of the invention;

FIG. 3 is a schematic diagram of a system comprising a further embodiment of a transmitter circuit in accordance with aspects of the invention and a further embodiment of a receiving circuit in accordance with aspects of the invention;

FIG. 4 is a schematic drawing of an audio signal communication cable embodying the invention;

FIG. 5 is a schematic diagram illustrating components of a system embodying aspects of the invention;

FIG. 6 is a schematic drawing of a guitar including the FIG. 1A or FIG. 1B circuitry and embodying the invention;

FIG. 7 is a schematic drawing of a microphone including the FIG. 1A or FIG. 1B circuitry and embodying the invention;

FIG. 8 is a schematic drawing of a mixing desk or alternative amplification equipment including the FIG. 2 circuitry and embodying the invention;

FIG. 9 is a schematic diagram of a system comprising a further embodiment of a transmitter circuit in accordance with aspects of the invention and a further embodiment of a receiving circuit in accordance with aspects of the invention;

FIG. 10 is a schematic drawing of a further embodiment of a transmit circuit in accordance with aspects of the invention; and

FIG. 11 is a schematic drawing of a further embodiment of a receiver circuit in accordance with aspects of the invention.

### DETAILED DESCRIPTION

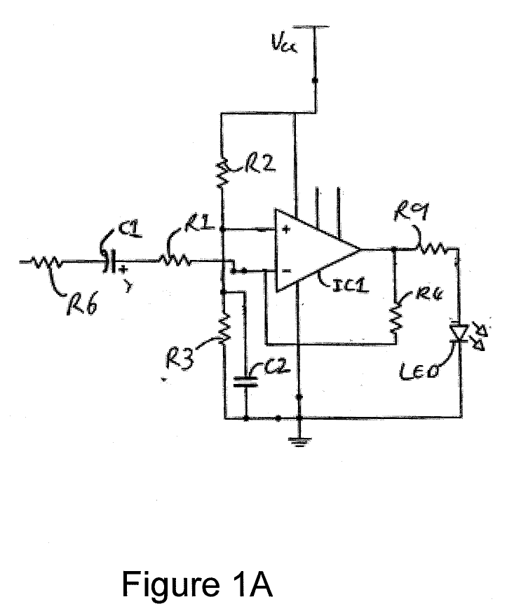

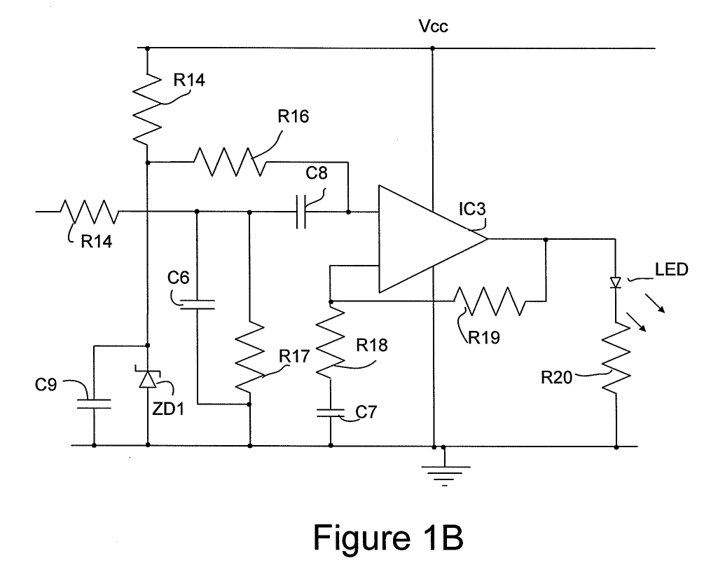

Referring to FIG. 1A, circuitry comprises a signal conversion and modulation arrangement based around a 741 operational amplifier (op-amp) IC1. First and second potential divider resistors R2, R3 form a potential divider between Vcc and ground potential. A capacitor C2 is connected in parallel across the ground-connected potential divider resistor R3. The capacitor C2 acts as a power buffer. It stabilises the linearity of the power supply. The mid-point of the potential divider is connected directly to a non-inverting input of the op-amp IC1. An inverting input of the op-amp IC1 is connected to receive a single-ended input signal via an input circuit comprising a first input resistor R6, an input capacitor C1 and a second input resistor R1 connected in series. A feedback resistor R4 is connected between a high impedance output of the op-amp IC1 and the inverting input thereof. The op-amp is powered by connections to Vcc and ground potential.

As a result, the op-amp IC1 produces an output signal having a centre voltage determined by the values of the potential divider resistors R2, R3 and the value of Vcc and varying with the varying input signal with a gain dependent on the value of the feedback resistor R4.

The output of the op-amp IC1 is connected through an output resistor R9 and a series-connected light emitting diode (LED) LED to ground potential. This arrangement ensures that the LED is provided with a voltage above the 0.7V diode drop voltage to approximately half of its working voltage threshold. For instance, the voltage applied to the LED (that is, the voltage across the output resistor R9) may be 5V or so.

An electrical signal received at the input circuit is dc blocked by the input capacitor C1 and received at the op-amp IC1. The op-amp IC1 provides an amplified version of the input signal, although typically the gain is low so relatively little amplification is provided, to the LED via the output resistor R9. Fluctuations in the input signal result in corresponding fluctuations in the current flowing through the LED, which results in a corresponding fluctuation in the intensity of light produced thereby. Thus, the LED produces an optical signal with a brightness or intensity varying with the amplitude of the input signal. Put another way, the received electrical signal is amplitude modulated onto an optical signal produced by the LED. Moreover, if the amplification is linear and the intensity of the LED varies linearly with applied voltage, then the amplitude modulation of the optical signal is a faithful representation of the received electrical analogue signal, and signal degradation is minimised and signal purity is retained.

The inventor has found that some models of LED are more linear than others, and that there are many LEDs available that are highly linear. However, since LEDs are not typically purchased for the linearity of their applied voltage versus output light intensity characteristics, LEDs do not tend to be advertised as having the properties which make them particularly suitable for use with this invention.

FIG. 1B shows a circuit which is alternative to the FIG. 1A circuit and constitutes a second embodiment. Here, a 741 operational amplifier IC3 is powered by connections to Vcc and ground rails. A circuit input is connected to a non-inverting input of the op-amp IC3 by an input resistor R14 and a dc blocking capacitor C8 connected in series. The dc blocking capacitor C8 is closest to the op-amp IC3. The node between the input resistor R14 and the dc blocking capacitor C8 is connected to ground by a grounding capacitor C6 and a grounding resistor R17 connected in parallel. An inverting input of the op-amp IC3 is connected an output of the op-amp by a feedback resistor R19 and is connected to ground potential by a second grounding resistor R18 and a second grounding capacitor C7 connected in series. A divider is formed between Vcc and ground by a resistor R14, which is connected directly to Vcc, and a Zener diode ZD1 and a capacitor C9, which are connected in parallel to each other and to ground. The node between the resistor R14 and the other components of the divider is connected to the non-inverting input of the op-amp IC3 by a further resistor R16. The Zener diode ZD1 biases the op-amp IC3 to about 4 Volts. This allows continued operation even when supply voltage falls significantly below 12 Volts. The FIG. 1b circuit has a high input impedance so is particularly suitable for use with guitars and the like. Operation of the circuit will be apparent to the skilled person so is not described in detail here.

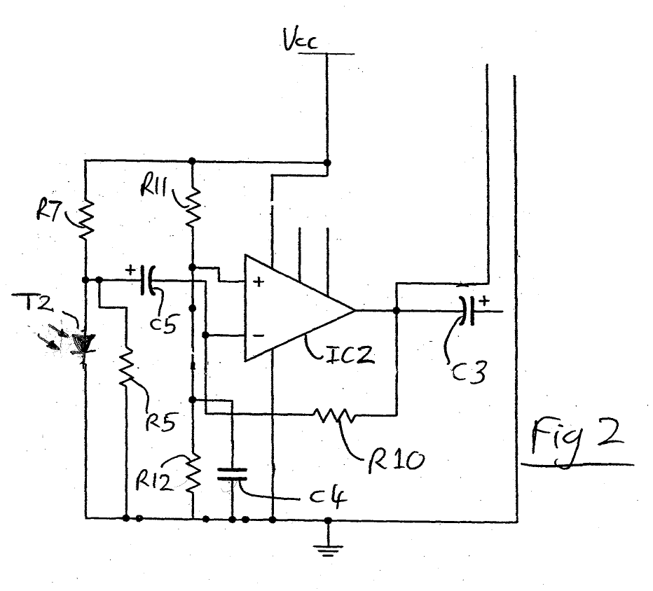

Referring now to FIG. 2, a receiving circuit is shown based around a 741 op-amp IC2. The op-amp IC2 is powered by connections to Vcc and ground potential. A non-inverting input of the op-amp IC2 is connected to the mid-point of a first potential divider formed by first and second potential divider resistors R11, R12 connected in series between Vcc and ground potential. A first capacitor C4 is connected across the ground-connected second potential divider resistor R12. The capacitor C4 acts as a power buffer. It stabilises the linearity of the power supply.

An input circuit comprises a second potential divider formed from third and fourth potential divider resistors R7, R5 connected between Vcc and ground potential, a photodiode T2 connected across the ground-connected fourth potential divider resistor R5, and a dc blocking capacitor C5 connected between the mid-point of the second potential divider and an inverting input of the op-amp IC2. The photodiode T2 is arranged to receive the optical signal produced by the LED of FIG. 1A or FIG. 1B, which has an audio signal amplitude modulated onto it. The photodiode T2 may take any suitable form, and may for instance be a PIN photodiode. Transmission of the optical signal typically occurs through an optical fibre cable.

A feedback resistor R10 is connected between an output of the op-amp IC2 and the inverting input thereof, to control the gain of the op-amp. A double-ended electrical output is provided by a terminal connected to the output of the op-amp and a terminal connected to ground potential. A capacitor C3 is connected to the output of the op-amp IC2. This provides an alternative output, which is dc blocked. Which of the output terminals is used depends on the requirements of the particular signal receiving device.

The resistance of the photodiode T2 is determined by the intensity of light incident on it. Thus, the resistance of the photodiode T2 varies with the modulation on the optical signal produced by the LED of FIG. 1A or FIG. 1B. The varying resistance of the photodiode T2 is translated into a varying voltage by the second potential divider R7, R5. The ac component of this varying voltage is received at the inverting input of the op-amp IC2 through the input capacitor C5, which blocks the dc voltage. The resulting signal is a high impedance signal having an instantaneous voltage directly dependent on the amount of light incident on the photodiode T2.

The varying ac voltage received at the inverting input of the op-amp IC2 is amplified and buffered by the op-amp IC2, and the result provided, with reference to ground potential, at the high impedance output of the op-amp IC2.

Thus, the FIG. 2 circuit receives an amplitude modulated optical signal and demodulates and converts it to provide analogue electrical audio frequency signals. Moreover, if the amplification is linear and the resistance of the photodiode varies linearly with received light intensity, then the resulting electrical analogue signal is a faithful representation of the amplitude modulation present on the received optical signal. In this way, signal degradation can be minimised and signal purity retained.

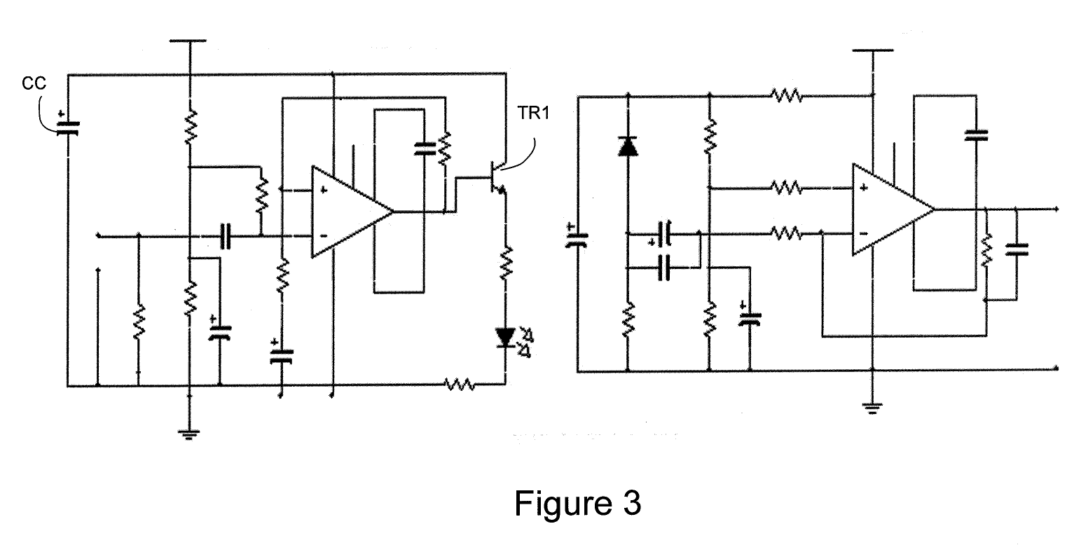

Referring now to FIG. 3, a further embodiment of a transmitter circuit and a further embodiment of a receiving circuit are shown.

The transmitter circuit (on the left side of FIG. 3) is the same as the FIG. 1B circuit except that a transistor TR1 is connected to the output of the op-amp IC2 to drive the PIN diode. This reduces shot noise at the receiver with more power. This is not crucial to the design, but avoids any requirement to re-bias the op-amp IC2. The diode LED may operate at 10 mA, modulating up to 20 mA and down to 1 mA.

If an NE5534 op-amp is used as the op-amp IC2, it is desirable to include a compensation capacitor CC connected between Vcc and ground potential.

The receiving circuit (on the right side of FIG. 3) is the same as FIG. 2 except that the diode is coupled via capacitors. Also, the feedback loop has a small value capacitor C10, which attenuates extraneous high frequency signals and prevents oscillation. The output has a coupling capacitor (not shown).

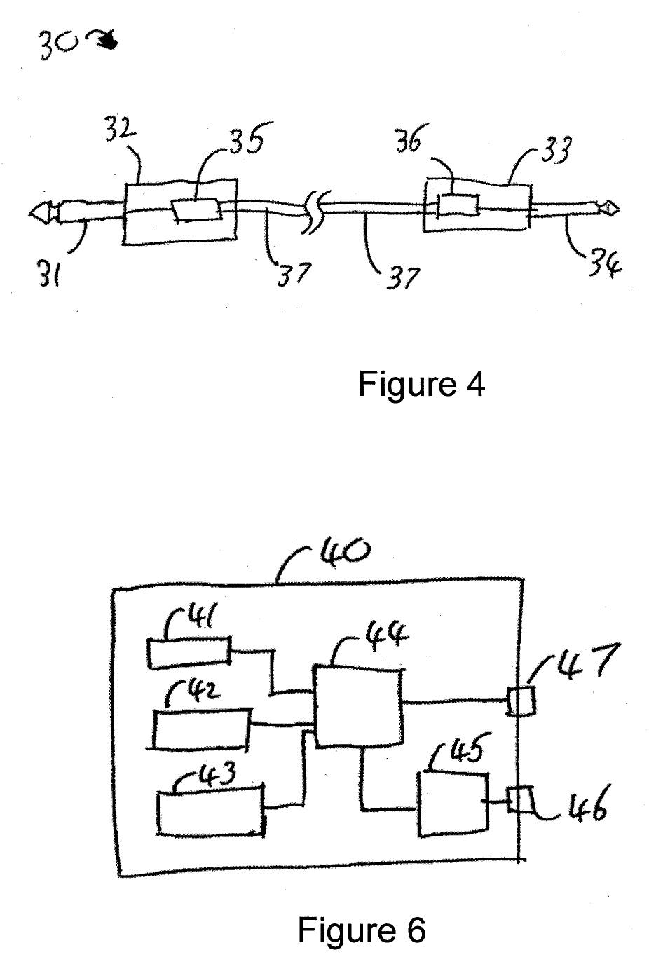

FIG. 4 shows a cable arrangement 30 according to various aspects of the invention. A first jack includes a first metallic ¼ inch plug 31 and a corresponding body 32. Within the body of the first jack is a first device 35 comprising the FIG. 1A transmitter circuit, the FIG. 1B transmitter circuit or the transmitter circuit of FIG. 3 and a 12V battery. The circuit in the device 35 is connected to the first plug 31 so as to be able to receive analogue electrical audio frequency signals applied thereto. The LED of the circuit in the first device 35 is arranged so as to pass the light that it emits into an end of a shielded optical fibre 37. At an opposite end of the optical fibre 37, a second device 36 is included in a body of a second jack, which includes a second ¼ inch plug 34. The second device 36 includes the FIG. 2 circuit or the receiver circuit of FIG. 3 and a 12V battery. The photodiode T2 in the second device 36 is arranged to receive light transmitted down the optical fibre 37. The electrical output of the second device 35 is provided to the second plug 34.

The cable arrangement 30 is used by mating the first plug into a signal out socket of a guitar or other sound source, and by mating the second plug 34 into a signal in socket of a mixing desk or amplification device or similar. When the guitar is played, analogue electrical audio frequency signals are provided to the conductors of the first plug, and thus are carried to the input of the transmitter circuit included in the first device 35. The first device thus amplitude modulates the audio signal onto an optical signal, which is transmitted along the optical fibre 37. The amplitude modulated optical signal is received at the second device 36, where the amplitude modulation is converted into an electrical analogue audio frequency signal and provided to the conductors of the second plug 34 and thus the amplification device mixing desk that it is connected to. The signals produced by the audio source thus are carried to the amplification device or mixing desk without being digitised and without being transmitted along a shielded electrical cable.

The inventor has constructed prototypes of the FIG. 4 cable arrangement 30. The prototype used 470Ω resistors for resistors R6, R9, 47 kΩ resistors for resistors R2, R3, R11 and R12, a 1 kΩ resistor for resistor R1, a 68 kΩ resistor for resistor R7, a 680 kΩ resistor for resistor R10, a 33 kΩ resistor for resistor R5 and a 10 kΩ resistor for resistor R4. It also used 10 μF capacitors for capacitors C1, C5 and C3, and 10 nF capacitors for C2 and D4. Low volume 12V batteries were used.

With inexpensive TL071 ICs for the op-amps IC1 and IC2, transmission signal quality was very high. It is expected that quality would be even better with OPA627 or other high quality ICs.

Manual distortion of the prototype optical cable 37 results in no audible change in signal, since there is no signal degradation in the optical cable 37.

Since current consumption of the FIGS. 1, 2 and 3 circuits is low, the batteries were able to power their respective circuits correctly for many hours before requiring replacement.

The cable arrangement 30 suffers some disadvantages compared to the conventional electrical cable arrangement. In particular, a power supply is needed at each end of the cable arrangement, whereas this is not true of the electrical cable. Also, the cable arrangement 30 is unidirectional, and can carry audio signals only from the first jack to the second jack. As a result of this, the inventor considers that the two jacks should be visibly different from one another, for instance by the inclusion of arrows indicating the direction of signal transmission, or through the use of different patterning or colouring. The conventional electrical cable on the other hand is bidirectional.

A break in the optical cable would normally result in the ceasing of incorrect transmission, although such can also occur with conventional electrical cables.

The inventor has discovered that different audio sources produce different signal voltages. For instance, an electric guitar produces an output signal having a maximum swing of 3 or 4 Volts, whereas certain microphones produce only 50 mV or so. Although a cable arrangement optimised for use with an electrical guitar functions also with a microphone source, the converse is not true. Also, a cable arrangement capable of handling a relatively small signal swing, for instance 100 mV, is optimised for use with microphone sources and is better able to handle microphone-originating signals without degradation. Accordingly, different cable arrangements, each optimised for a particular voltage swing, may provide improved results than a single, all-purpose arrangement.

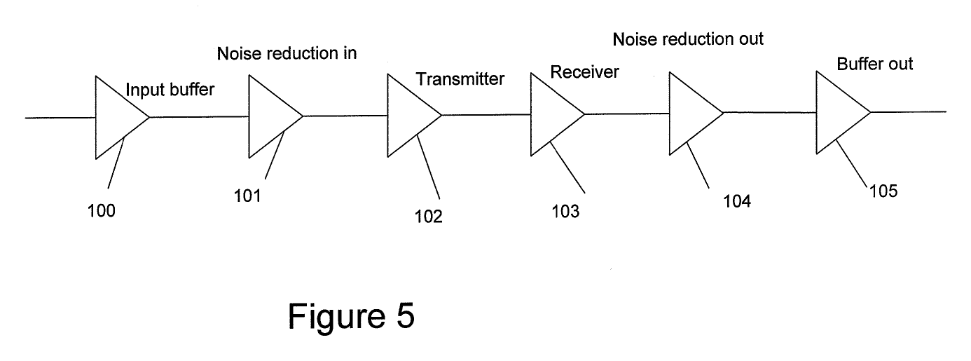

Implementation of noise reduction in the system is achieved by the arrangement shown in FIG. 5. In the Figure, a unidirectional chain is formed by an input buffer 100, a first noise reduction element 101, a transmitter 102, a receiver 103, a second noise reduction element 104 and an output buffer 105. The FIG. 5 arrangement may be provided as a cable arrangement, like the one shown in FIG. 4, or it might be system made up of separate components, for instance a transmitter station, a receiver station and an optical cable. The FIG. 5 arrangement is described hereafter as a unitary cable arrangement.

The input buffer 100 impedance matches the input source signal. This helps to maintain signal purity and fidelity. The output impedance of a guitar is very high, which is in contrast to a line level signal input. A microphone level input also has a different impedance value. The input buffer 100 may be a unity gain op-amp or a small capacitor/resistor network. The input buffer may adjust signal amplitude so as to provide a desired signal swing. In this way, the input buffer 100 allows signal sources having different levels to be used. To use the system with a different type of source, a different input buffer is needed.

The first noise reduction element 101 is optional, and if present provides conditioning of the signal prior to transmission through the system. This maximizes the available bandwidth throughout the optical cable in an AM transmission. Whereas an electrical cable carries an electrical signal regardless of the input dynamic range, the optical system of the present invention can be tailored to suit the source with which it is to be used. Either different cable arrangements, each with a different noise reduction element 101, can be used for different sources, or alternatively a noise reduction element 101 is controllable having regard to a position of a switch on the cable arrangement (or other input) to vary the processing technique effected by the noise reduction element 101. The processing effected by the noise reduction element 101 can be any suitable noise reduction or bandwidth maximising technique. Many such techniques, using Psychoacoustics or Temporal Masking, are known.

Noise reduction processing techniques have for some time been used by record player circuits. For instance, signals are attenuated from 20 Hz to 1 kHz in a low to high ramp and then boosted from 3 kHz upward to 20 kHz. Because bass frequencies often dominate dynamic range, such attenuation allows more headroom for the system.

The transmitter 102 can take any suitable form, such as the transmitter of any of FIG. 1A, 1B or 3. The transmitter 102 supplies optical signals to an optical fibre connected between it and the receiver 103.

The receiver 103 can take any suitable form, such as the receiver of FIG. 2 or the receiver of FIG. 3. The receiver 103 receives optical signals from the transmitter and demodulates them.

The second noise reduction element 104 performs the inverse of the processing performed by the first noise reduction element 101. If the first noise reduction element 101 is controllable, the second noise reduction element 104 is informed what processing technique it needs to use in order correctly to restore the input signal.

The boosting of the high end frequency by the first noise reduction block 103 enables elimination of or at least reduction of any shot or circuit noise present at the diode of the receiver 103.

The second buffer 105 provides impedance matching to the device or system that the cable arrangement is to be connected to.

FIG. 6 illustrates schematically an electric guitar 40 according to aspects of the invention. The guitar includes three transducers, namely a neck humbucker 41, a middle coil 42 and a bridge humbucker 43. Each of these is connected to an electronic switching circuit 44, which includes controllable potentiometers. The switching circuit 44 provides electrical analogue signals at audio frequencies to a socket 47, with which a ¼ inch plug can be mated. The guitar thusfar described is conventional.

The guitar 40 also includes a circuit 45, which comprises the FIG. 1A or FIG. 1B circuit, the FIG. 3 transmitter circuit, or similar. The circuit 45 is connected to receive electrical analogue signals at audio frequencies from the switching circuit 44. The circuit 45 is powered by a power source, such as a 12V battery (not shown) included in the guitar 40. The circuit 45 amplitude modulates the electrical analogue signal onto an optical signal and provides the result to an optical connector 46 mounted on a face of the housing of the guitar 40. An optical cable (not shown) is connectable into the optical connector 46, and carries the optical signal generated by the circuit 45 away from the guitar. Thus, the guitar 40 provides an optical amplitude modulated signal in the same way that a combination of a conventional guitar and the first jack of the FIG. 4 cable arrangement 30 would provide. All of the benefits stated above with relation to the previous Figures apply to this embodiment. Since it includes an electrical signal output socket 47, the guitar 40 also is usable conventionally, although this can be omitted if not required.

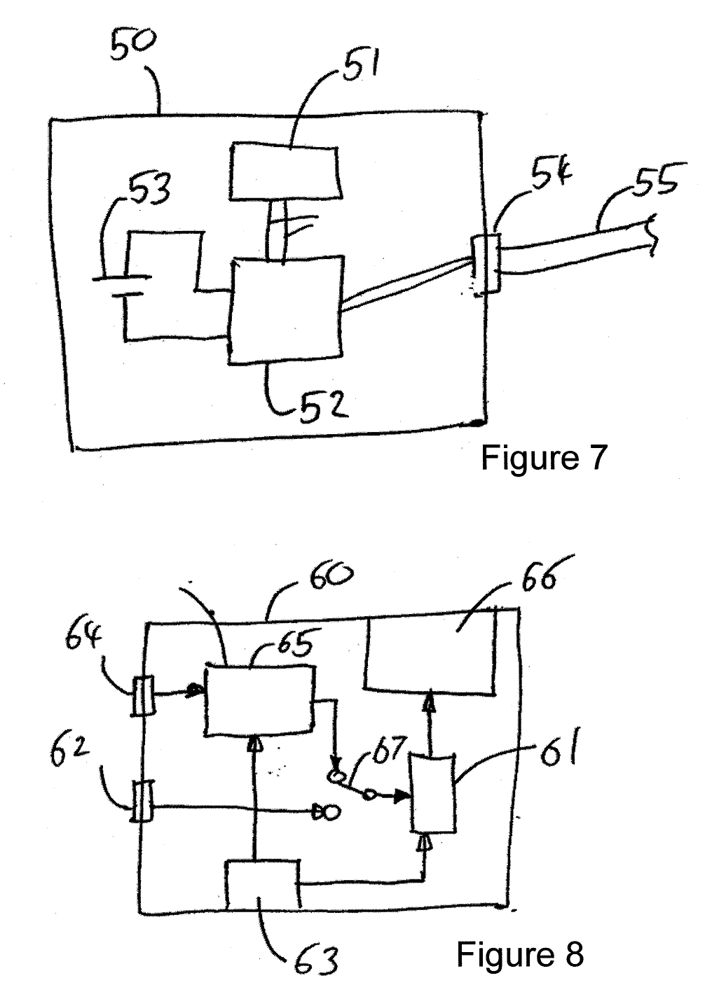

FIG. 7 illustrates schematically a microphone 50 according to aspects of the invention. The microphone 50 includes a microphone transducer 51, as is conventional. The microphone transducer is connected to a circuit 52, which comprises the FIG. 1A or FIG. 1B circuit, the FIG. 3 transmit circuit or similar. The circuit 52 is powered by a battery 53 The circuit 52 is connected to receive electrical analogue signals at audio frequencies from the microphone transducer 51. The circuit 52 amplitude modulates the electrical analogue signal onto an optical signal and provides the result to an optical connector 54 mounted on a face of the housing of the microphone 50. An optical cable 55 is removably or fixedly connected into the optical connector 54, and carries the optical signal generated by the circuit 52 away from the microphone 50. Thus, the microphone 59 provides an optical amplitude modulated signal in a way similar to that of the FIG. 6 guitar 40 or the FIG. 1A, FIG. 1B and FIG. 3 transmit circuits.

FIG. 8 shows an amplification device, commonly known as an amplifier. An integral power supply 63 receives mains electricity, and powers a conversion circuit 65 and an amplifier circuit 61. The amplifier circuit 61 is connected via a user-operable switch 67 selectively to receive an electrical analogue signal from an input socket 62 or to receive an electrical analogue signal from the conversion circuit 65. The conversion circuit 65 is as the FIG. 2 circuit, the FIG. 3 receiver circuit or similar. It receives amplitude modulated optical signals through an optical cable (not shown) mated with an optical connector 64 included in a face of the housing of the amplifier 60. The amplifier circuit 61 amplifies the electrical it receives from the switch 67 and provides a low impedance power signal to a speaker 66, thereby to produce an audible signal based on the received signals. Thus, the amplifier 60 is operable to process received amplitude modulated optical signals and produce audio signals therefrom. The amplifier can be considered to be the second jack of the FIG. 4 cable arrangement integrated with a conventional amplifier. The electrical connector 62 can be omitted if not required.

FIG. 8 alternatively shows schematically components of a mixing desk 60, such as may be used in a studio to produce and record music. Here, an integral power supply 63 receives mains electricity, and powers a conversion circuit 65 and a low-power amplifier circuit 61. The amplifier circuit 61 is connected via a user-operable switch 67 selectively to receive an electrical analogue signal from an input socket 62 to receive an electrical analogue signal from the conversion circuit 65. The conversion circuit 65 is as the FIG. 2 of FIG. 3 receiver circuit, or similar. It receives amplitude modulated optical signals through an optical cable (not shown) mated with an optical connector 64 included in a face of the housing of the mixing desk 60. The amplifier circuit 61 amplifies the electrical it receives from the switch 67 and provides a high impedance signal to sound processing/recording circuitry 66. Thus, the mixing desk 60 is operable to process received amplitude modulated optical signals and produce electrical representations of audio signals therefrom for processing and/or recording. The mixing desk 60 can be considered to be the second jack of the FIG. 4 cable arrangement integrated with a conventional mixing desk. The electrical connector 62 can be omitted if not required.

In an alternative embodiment, the FIG. 2 or FIG. 3 receiver circuit or similar is provided on an interface card for connection to a computer. In this embodiment, the interface card includes a high quality digital-to-analogue converter for converting the demodulated audio signals into a digital signal, for processing and/or recording by a computer.

Although the above describes that the sound source can be a guitar or microphone, the sound source may be any other type that produces analogue audio signals. The invention has most advantage with sound sources which are moved around during a performance, since these are most likely to have electrical cables damaged during use.

An additional advantage is electrical isolation. Conventional cabling includes electrical conductors. In the event of faulty amplification equipment, electrical power could be transferred through the cable to a guitar player or other person, potentially resulting in electrical shock. The same could occur in the event of a lightning strike, which are not uncommon at outdoors concerts and the like. Using an optical fibre to convey audio signals, on the contrary, provides electrical isolation between the ends of the cable, and thus provides improved safety.

The human ear is able to perceive audio signals between 20 Hz and 20 kHz, so it is normally only those signals that are of interest to a musician or sound producer. However, the carrying also of additional signal frequencies is not precluded by the invention, as long as the content of primary interest is in the audible frequency range.

Since the signal of interest is amplitude modulated onto the optical signal, the nature of the light source is not important, as long as the amplitude of its output is controllable. The light source need not be a single frequency source, or even fixed in frequency. An LED makes a good light source because of its ease of use and low cost.

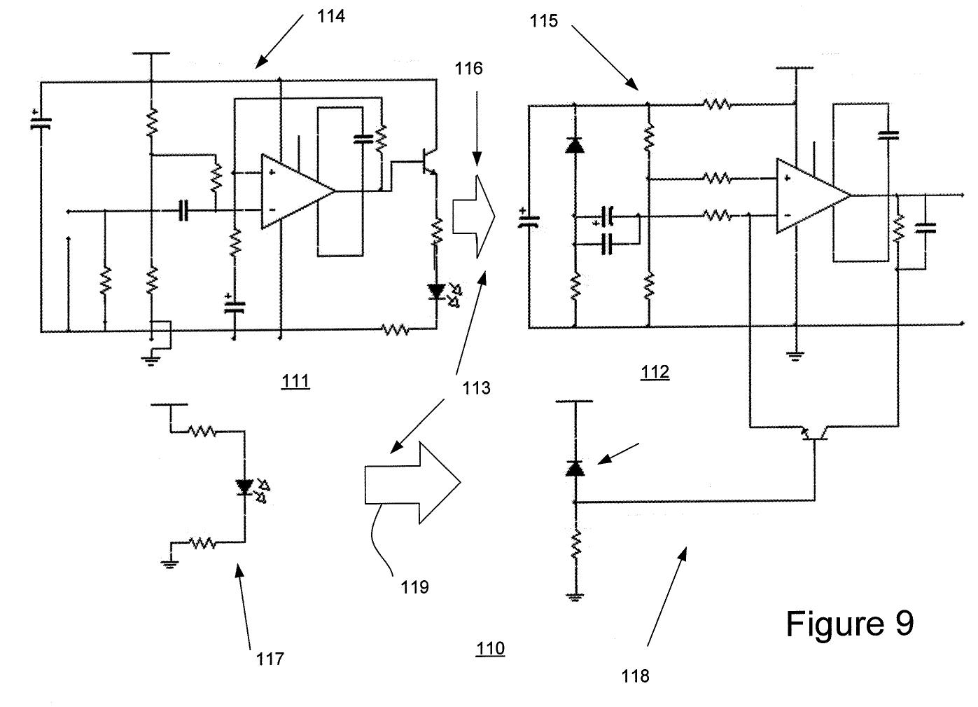

The inventor has realised that attenuation of a signal passing through an optical cable as a result of excessive bending of the cable could result in undesirable signal modification. In a digital system, attenuation is not a problem when transmission is over short distances. When amplitude or intensity modulation is used, however, excessive cable bending can reduce output signal swing. The effects of this are mitigated by the system shown in FIG. 9.

Referring to FIG. 9, a system 110 includes a transmit arrangement 111 connected to a receive arrangement 112 by an optical cable 113. The transmit circuit 111 includes a transmit circuit 114, which is the same as the transmit circuit of FIG. 3. the transmit circuit 114 is connected to a receive circuit 115, which is the same as the receive circuit of FIG. 3, by a first core 116 of the optical cable 113. A reference transmit circuit 117 is connected to a reference receive circuit 118 by a second core 119 of the optical cable 113.

The reference transmit circuit 117 transmits a constant optical signal at a constant intensity. The reference receive circuit 118 is connected to the receive circuit 115 so as to control the gain of the receive circuit 115 in dependence on the intensity of light received over the second core 119. Less intensity gives rise to increased gain, with a linear variation.

When there is no bending of the optical cable 113, there is little or no attenuation of light by the cores 116, 119. When there is substantial bending, there is attenuation by both cores 116, 119. The amount of attenuation is approximately equal in both cores 116, 119. Thus, the increase in gain of the receive circuit 115 in the presence of less light intensity at the reference receive circuit 118 gives rise to compensation for attenuation in the first core 116. Through suitable control of the gain of the receive circuit 115 by the reference receive circuit 118, the output of the receive circuit 115 has a desired signal swing (for a given input signal swing) even if the optical cable 113 is bent to the extent that light attenuation occurs.

Alternative arrangements for compensating for signal attenuation in the optical cable will be apparent to those skilled in the art. For instance, a light dependent resistor could be used in place of the photodiode in the reference receive circuit 118.

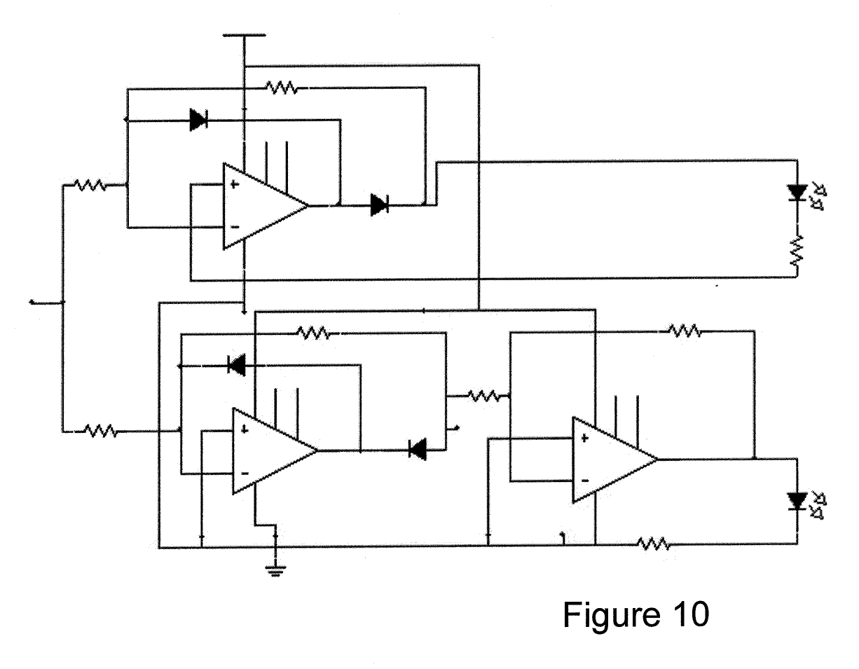

FIG. 10 shows a further embodied receive circuit 120. This is a dual PIN diode transmit circuit. The input signal is sent to two separate amplifier systems. The uppermost diode, driven by one of the amplifier systems, modulates the positive half cycle of the input waveform, and the lowermost diode, driven by the other amplifier system, modulates the negative half cycle of the input waveform. Each diode is operable between minimum and maximum illumination.

The circuit 120 is two half-wave rectifiers working together.

Each amplifier system includes an op-amp with a direct feedback diode. The feedback diodes are connected in different directions in the different amplifier systems. The direct feedback diodes shunt any output back to the inverting input directly, preventing it from being reproduced. Therefore the amplifier systems deal with opposite portions of the input waveform. The slight voltage drop across the diode itself is blocked from the output by the second diode.

A second diode in each amplifier system allows positive/negative going output voltage to reach its respective output. Since the output voltage is taken from beyond the output diode itself, the op-amp compensates for any non-linear characteristics of the diode itself. As a result, the output voltage is a true and accurate reproduction of the negative/positive portions of the input signal. The amplifier system handling negative half cycles includes an inverter, in this example including an op-amp, to invert the signal.

A corresponding receiving circuit (not shown) has two receiving pin diodes attached to inverting and non-inverting inputs of an op-amp. The output signal is recombined to reproduce the input signal.

This has the advantage of doubling the overall dynamic gain.

Advantages can be achieved by using an avalanche photodiode (APD) as the photodiode T2. In particular, the sensitivity of an APD is much higher that the sensitivity of other photodiode types. This can allow the APD to be used to provide an electrical signal to amplifier or other equipment without the pre-amplification used in the embodiments described above.

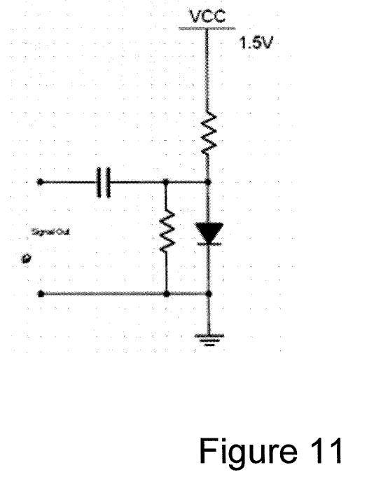

In an alternative embodiment (not shown), the receiver circuit of FIG. 2 or FIG. 3 is replaced by an APD, with or without additional circuitry. This does not require any source of electrical power, since the APD provides an electrical signal from the received light power. Although the APD is not capable of providing any significant current, the voltage signal (which can be around 500 mV peak-to-peak) is satisfactory for most implementations. A sample circuit is shown in FIG. 11.

Referring to FIG. 11, the further embodiment of a receiver circuit comprises a photodiode in series with a resistor between Vcc and ground. A drain resistor is connected across the photodiode, which increases the frequency at which response drops-off such that it is outside the audible range. Without the drain resistor, no switch is needed since the photodiode conducts only when light is incident on it. With the drain resistor in place, a switch (not shown) is connected so as to minimise unnecessary battery drain.

In a cable arrangement, this embodiment is particularly advantageous since the APD may be connected directly to terminals of a plug, and no electrical power supply or other components need to be provided. In a mixing desk or other amplification equipment, the advantages of using an APD in place of some other photodiode may not be so significant.

The optical cable and the connectors may take any suitable form, for example one of the many components commonly available in electronic component shops.

1. (canceled)

2. A system as claimed in claim 10, wherein the modulated optical signal comprises an optical carrier with amplitude modulations at between 20 Hz and 20 kHz, the amplitude modulations having direct correspondence with the audio signals.

3. A system as claimed in claim 10, in which the modulator comprises a semiconductor circuit arranged to apply an amplitude modulating signal to a light source.

4-7. (canceled)

8. A system as claimed in claim 10, comprising a compensator for compensating for signal attenuation in the optical waveguide.

9. A system as claimed in claim 10, wherein the modulator includes two half-wave rectifiers.

10. A cable arrangement comprising first and second devices connected by an optical waveguide,
the first device comprising:
a receiver for receiving an analogue electrical signal having content between 20 Hz and 20 kHz representing an analogue audio signal;
a modulator for modulating the analogue electrical signal onto an optical signal; and
an electrical connector for mating with a sound source;
the optical waveguide being arranged to carry the modulated optical signal to the second device; and
the second device comprising:
a receiver for receiving the modulated optical signal;
a demodulator for demodulating the modulated optical signal to produce an analogue electrical signal having audio signal content between 20 Hz and 20 kHz; and
an electrical connector for mating with an audio signal receiving device.

11-21. (canceled)
